(19) United States
(12) Patent Application Publication
(10) Pub. No.: US 2022/0019953 A1
(43) Pub. Date: Jan. 20, 2022

(54) PRODUCTION PLAN CREATION DEVICE AND NON-TRANSITORY COMPUTER READABLE MEDIUM

(71) Applicant: FUJIFILM Business Innovation Corp., Tokyo (JP)

(72) Inventors: Ryosuke TAKAHASHI, Kanagawa (JP); Kiyofumi AIKAWA, Kanagawa (JP); Shuhei KOBAYAKAWA, Kanagawa (JP)

(73) Assignee: FUJIFILM Business Innovation Corp., Tokyo (JP)

(21) Appl. No.: 17/224,131

(22) Filed: Apr. 7, 2021

(30) Foreign Application Priority Data
Jul. 17, 2020 (JP) 2020-122634

(51) Int. Cl. G06Q 10/06

(52) U.S. Cl. CPC G06Q 10/06316; G06Q 10/06311; G06Q 10/06312; G06Q 10/06393

(57) ABSTRACT

A production plan creation device includes a processor configured to acquire information about multiple tasks performed to produce a product using resources, determine a provisional order of two or more tasks among the multiple tasks while accounting for a predetermined condition for performing the multiple tasks, create a provisional plan in which resources are assigned in an order obtained by correcting the provisional order to account for the condition, and create a candidate plan on a basis of an evaluation of the provisional plan.

### CROSS-REFERENCE TO RELATED APPLICATIONS

This application is based on and claims priority under 35 USC 119 from Japanese Patent Application No. 2020-122634 filed Jul. 17, 2020.

### BACKGROUND

### (i) Technical Field

The present disclosure relates to a production plan creation device and a non-transitory computer readable medium.

### (ii) Related Art

For example, Japanese Unexamined Patent Application Publication No. 2002-108439 proposes a technology that determines an optimal production schedule for multiple products quickly and efficiently. The technology described in Patent Literature 1 is a method of determining a production schedule for products with multiple brands, and is a scheduling method including: (1) a means of assigning a priority to each brand to be produced on the basis of the remaining stock of the product, and (2) a means of constructing an evaluation function that includes the divergence between the priority and the production order of the production schedule, and a production cost, and computing the production schedule using a solution to a combinatorial optimization problem.

### SUMMARY

When creating a plan for a series of production steps containing multiple tasks, considering only matters related to productivity may result in a plan that does not make it easy for workers to move on to the next task even though the process for the previous task is completed quickly, for example. What factors to prioritize, such as productivity or ease of work, are different depending on the worksite where the work is actually performed, such as a factory that produces products, and it is desirable to be able to create a production plan that accounts for the circumstances at each worksite.

Aspects of non-limiting embodiments of the present disclosure relate to creating a plan that accounts for the circumstances at a worksite.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a production plan creation device including a processor configured to acquire information about a plurality of tasks performed to produce a product using resources, determine a provisional order of two or more tasks among the plurality of tasks while accounting for a predetermined condition for performing the plurality of tasks, create a provisional plan in which resources are assigned in an order obtained by correcting the provisional order to account for the condition, and create a candidate plan on a basis of an evaluation of the provisional plan.

### BRIEF DESCRIPTION OF THE DRAWINGS

Exemplary embodiments of the present disclosure will be described in detail based on the following figures, wherein:

FIG. 1 is a diagram illustrating a hardware configuration example of a production plan creation device according to a first exemplary embodiment;

FIG. 2 is a diagram illustrating one example of a block diagram illustrating a functional configuration of a control unit;

FIG. 3 is a diagram for explaining one example of a process until an assignment order is determined;

FIG. 4 is a diagram illustrating an example of deadline margin time, residence time, and total production time;

FIG. 5 is a flowchart illustrating one example of a process performed by the control unit;

FIG. 6 is a diagram illustrating one example of a candidate plan display screen displayed on a display screen of a display unit by a display control unit;

FIG. 7 is a diagram illustrating one example of a block diagram illustrating a functional configuration of a control unit according to a second exemplary embodiment; and

FIG. 8 is a diagram illustrating one example of a comparison screen displayed on the display screen of the display unit by the display control unit.

### DETAILED DESCRIPTION

Hereinafter, exemplary embodiments of the present disclosure will be described with reference to the attached drawings.

### First Exemplary Embodiment

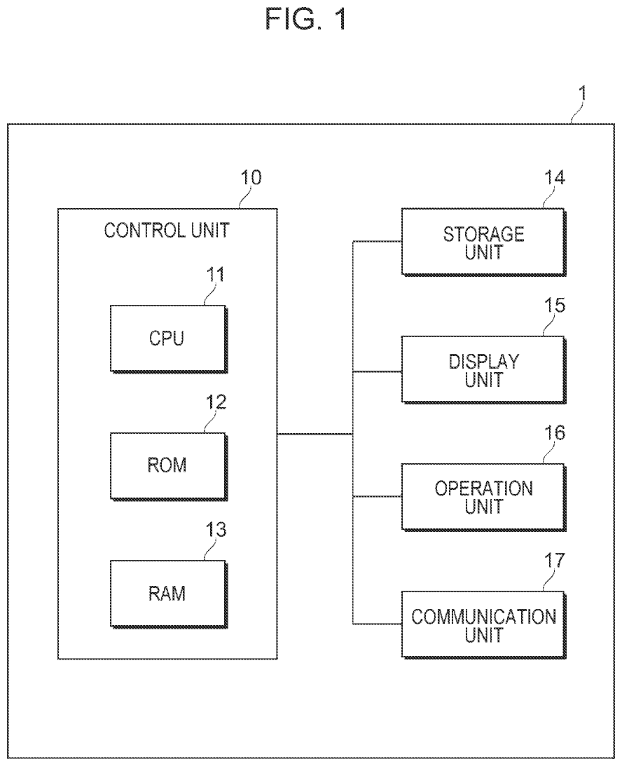

FIG. 1 is a diagram illustrating a hardware configuration example of a production plan creation device 1 according to a first exemplary embodiment.

The production plan creation device 1 according to the exemplary embodiment is a device that plans out dates and times when multiple products are to be produced at a site such as a factory that produces products using resources such as machines, for example. For example, in a factory that produces printed materials such as catalogs, posters, and flyers as examples of products, there is demand for printed materials requested for production using a printing machine as an example of a machine to be produced in time to meet a predetermined deadline. The production plan creation device 1 is a device that creates a production plan to meet deadlines while accounting for factors such as the time taken to produce the printed materials.

As illustrated in FIG. 1, the production plan creation device 1 is provided with a control unit 10. The control unit 10 includes a central processing unit (CPU) 11, read-only memory (ROM) 12 that acts as a storage area storing programs such as a basic input-output system (BIOS), and random access memory (RAM) 13 that acts as a program execution area.

The production plan creation device 1 is also provided with a storage unit 14 that stores various programs such as an operating system (OS) and applications, input data for the various programs, and output data from the various programs. The storage unit 14 may be a storage device such as a hard disk drive (HDD) or semiconductor memory, for example.

Additionally, the production plan creation device 1 is provided with a display unit 15 used to display an operation reception screen and images, an operation unit 16 that receives input operations from a user, and a communication unit 17 used to communicate with external devices.

The display unit 15 may be a liquid crystal display (LCD) or an organic EL (OLED) display, for example.

The operation unit 16 may be a keyboard, a mouse, or a touch panel, for example. In the case where the operation unit 16 is a touch panel, the touch panel functions as the operation unit 16 and the display unit 15.

The communication unit 17 may be a communication interface (communication I/F), for example.

The production plan creation device 1 may be a laptop personal computer (PC), a desktop PC, a tablet PC, a tablet, a personal digital assistant (PDA), or a multifunctional mobile phone (also known as a “smartphone”), for example.

### (Controller 10)

The control unit 10 acquires information about multiple tasks performed to produce a product using resources, and determines a tentative order (hereinafter referred to as the “provisional order” in some cases) of two or more tasks among the multiple tasks while accounting for a predetermined condition for performing the multiple tasks. Additionally, the control unit 10 creates a provisional plan in which resources are assigned in an order obtained by correcting the provisional order to account for the condition, and creates a candidate plan on the basis of an evaluation of the provisional plan. The predetermined condition is a condition specified by the user, and is a condition that is accounted for when determining the provisional order and also when determining a corrected provisional order obtained by correcting the provisional order. The predetermined condition may be a condition for determining a provisional order while excluding tasks that are assigned already, and inserting tasks that are assigned already to the front of the provisional order when correcting the provisional order, for example. Also, in the case where a grouping condition for grouping several of the multiple tasks together is specified, the predetermined condition may be a condition for determining a provisional order while excluding another task other than a first task among the multiple grouped tasks, and placing the other task in sequential order with the first task when correcting the provisional order, for example.

Here, in the following description, the case of producing requested printed materials will be illustrated as an example of tasks. In the case where the printed materials are a catalog for example, completing the printed materials may involve multiple steps such as a printing step, a cutting step, and a binding step, for example. The printing step is a step of a printing process executed by a printing machine on the basis of a print command that includes image data to be printed and settings for the process performed by the printing machine. The printing machine may be an offset printing machine or a digital image forming device such as a digital copier or a digital multi-function device, for example. Additionally, before the printing step, the print command is generated by performing work such as planning, editing, and layout of the printed materials after receiving image data provided by a client, and settings such as the number of pages or the number of copies to print and the type of paper to use for printing are determined. Also, a single print command is divided into the respective parts of the printed materials, such as “cover” and “body text” for example, and settings such as whether or not to perform the printing process for each part are also determined. Consequently, before the printing step, it is possible to predict how much work time will be taken in each of the steps such as the printing step, the cutting step, and the binding step, or how much preparation time will be taken between steps, until the printed materials are completed. Note that preparation time includes the time taken to transport materials between machines, such as from the printing machine to the cutting machine, for example.

In the case where the production of multiple printed materials is requested, ordinarily, a deadline is set by the request for each of the printed materials, and there is a demand to proceed with each step to meet the deadline. Accordingly, the control unit 10 plans out the date and time of each step while accounting for factors such as the running time and the stopped time of the machines such as the printing machine that performs a printing process in the printing step, the cutting machine that performs a cutting process in the cutting step, and a binding machine that performs a binding process in the binding step, and also factors such as the work times and break times of workers.

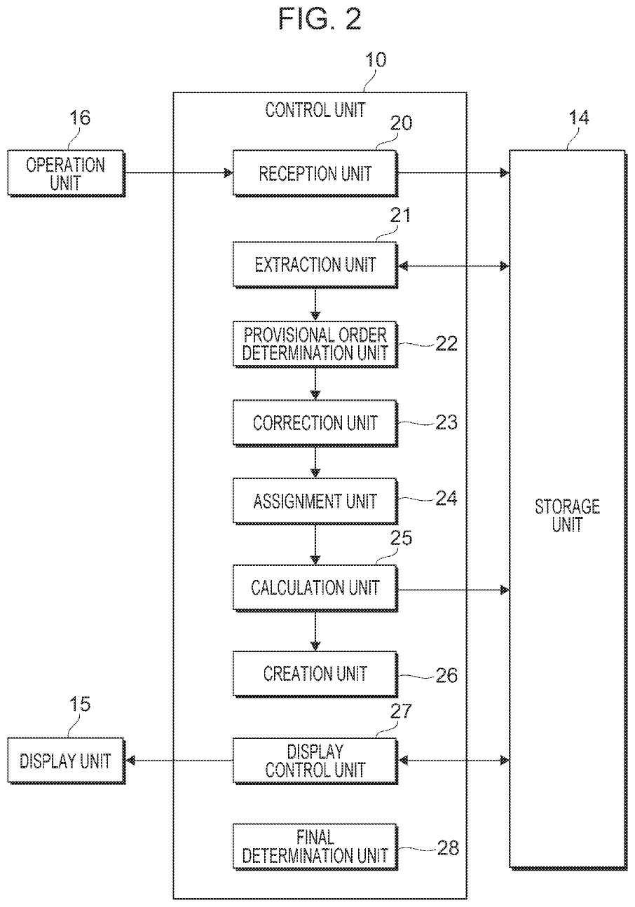

FIG. 2 is a diagram illustrating one example of a block diagram illustrating a functional configuration of the control unit 10.

The control unit 10 includes a reception unit 20 that receives information input by the user through the operation unit 16. The control unit 10 is also provided with an extraction unit 21 that extracts multiple tasks when determining the provisional order for assigning multiple tasks for which to create a production plan (hereinafter referred to as the “planning target tasks” in some cases) and a provisional order determination unit 22 that determines a provisional order of the multiple tasks extracted by the extraction unit 21. Additionally, the control unit 10 is provided with a correction unit 23 that corrects the provisional order determined by the provisional order determination unit 22 according to a predetermined rule, and an assignment unit 24 that assigns a corrected provisional order corrected by the correction unit 23 to resources such as machines and workers. The control unit 10 is also provided with a calculation unit 25 that calculates a key performance indicator (hereinafter referred to as “KPI” in some cases) for the plan assigned by the assignment unit 24, and a creation unit 26 that uses the KPI calculated by the calculation unit 25 to create a candidate plan that acts as a candidate of a final plan. Also, the control unit 10 is provided with a display control unit 27 that causes the plan created by the creation unit 26 to be displayed on a display screen of the display unit 15, and a final determination unit 28 that determines the final plan.

Hereinafter, each component included in the control unit 10 will be described.

### (Reception Unit 20)

The reception unit 20 is capable of receiving planning target tasks. The reception unit 20 is also capable of receiving information related to planning target tasks and information related to resources. The information related to planning target tasks may be a customer, a deadline, and a product shipping destination, for example. The information related to resources may be information about the running state of machines, information about the work times of workers, and the like.

The reception unit 20 receives information input by the user through the operation unit 16 and information transmitted from a processing device different from the production plan creation device 1, such as a laptop PC, a desktop PC, a tablet PC, a tablet, a personal digital assistant (PDA), or a multifunctional mobile phone (also known as a “smartphone”).

The reception unit 20 is capable of receiving a grouping condition for grouping several of the multiple tasks. The grouping condition may be a condition for grouping tasks for the same customer, grouping multiple tasks for the same or related products, grouping multiple tasks for products having the same type of paper, and grouping multiple tasks having product shipping destinations in the same geographical region, for example. In addition, the grouping condition may be a condition for grouping tasks in an order that makes it easy for a worker to perform the work, grouping tasks to be in the same order as the page order of a product, grouping tasks for products having the same color, and grouping tasks for products having the same size, for example.

The reception unit 20 is also capable of receiving a work method or a processing method for tasks. For example, the reception unit 20 is capable of receiving a specification of a machine with respect to a task, a specification of a worker with respect to task, and a specification of a work time of a worker with respect to a task. Also, the reception unit 20 is capable is receiving a specification such as dividing a task into predetermined units or assigning a task to multiple machines at the same time.

The reception unit 20 is also capable of receiving information about the times of tasks and resources. For example, the reception unit 20 is capable of receiving a specification of the time between a first step and another step in a single task, a specification of the time between a first task and another task at the same machine, a specification of working hours, a specification of the priority of a task, a specification of a target work completion date and time for a task, and a specification of a work acceleration limit time for a task. Additionally, the reception unit 20 is capable of receiving a specification of a deadline margin time that is desirable to secure for a single task and a specification of an allowed quantity as the inventory of work in process or a finished product. Note that the deadline margin time for a task is the amount of time obtained by subtracting the projected completion time of the last step in the task from the deadline, that is, the projected delivery date and time of the product produced by the task.

The reception unit 20 is also capable of receiving a priority setting for a task. For example, the reception unit 20 is capable of receiving a specification of a priority with respect to inventory, such as work that is not to be performed if the inventory is at or above a predetermined upper limit, or work that is to be prioritized if the inventory is at or below a predetermined lower limit, and a specification of a priority with respect to a customer. The reception unit 20 is also capable of receiving a task for which a production plan is already created, or in other words, a task that is already assigned. The reception unit 20 is also capable of receiving settings for a retention condition of a task in progress, such as a retention period, a machine to retain, and a worker to retain, for example.

The reception unit 20 is also capable of receiving a KPI specified by the user.

In the case of receiving information input by the user, the reception unit 20 stores the received information in a predetermined storage area in the storage unit 14.

### (Extraction Unit 21)

The extraction unit 21 extracts tasks to include in the provisional order from among the planning target tasks.

The extraction unit 21 acquires information about the planning target tasks. Also, in the case where an already-assigned task exists, the extraction unit 21 acquires information about the task. Also, in the case where a grouping condition for grouping several tasks from among the planning target tasks is specified, the extraction unit 21 acquires a predetermined grouping condition (for example, grouping multiple tasks for the same customer). The extraction unit 21 acquires the information from a predetermined storage area in the storage unit 14.

Additionally, in the case where an already-assigned task exists the extraction unit 21 excludes the already-assigned task from the planning target tasks. Also, in the case where tasks that satisfy a grouping condition exist, the extraction unit 21 excludes tasks other than one of the grouped tasks (for example, the task with the earliest deadline) from the remaining multiple tasks. With this arrangement, the extraction unit 21 extracts a task that has not been assigned or one of the grouped tasks from among the planning target tasks.

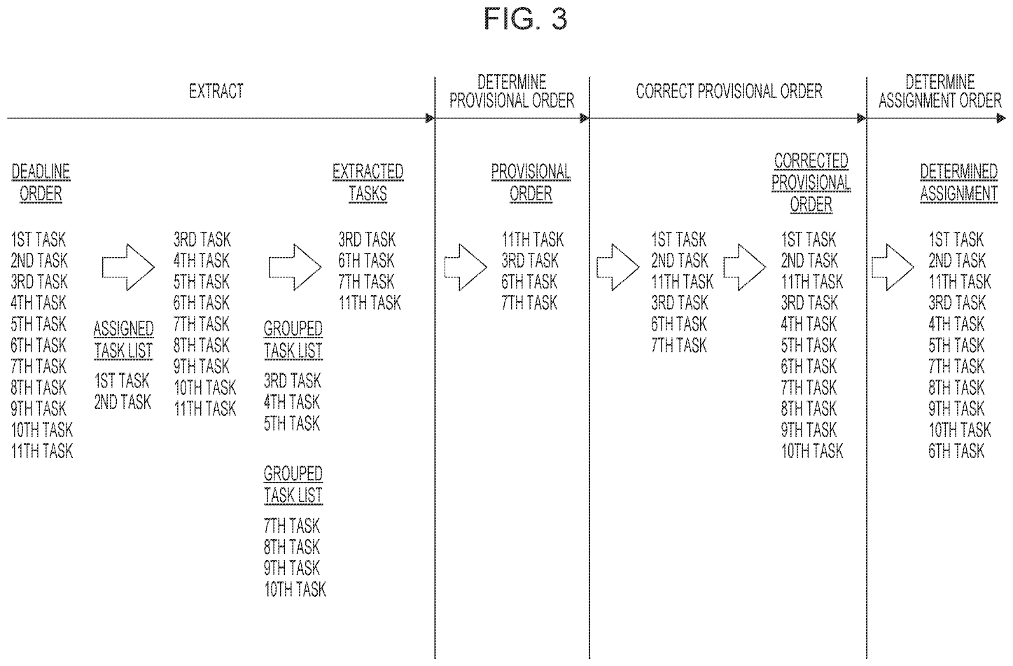

FIG. 3 is a diagram for explaining one example of a process until an assignment order is determined.

FIG. 3 will be used to describe a process of extraction performed by the extraction unit 21.

The example illustrated in FIG. 3 assumes that there are 11 planning target tasks. These 11 tasks will be referred to as the 1st to 11th tasks, where a smaller number denotes an earlier deadline. Additionally, it is assumed that the 1st task and the 2nd task are already assigned. Also, it is assumed that the 3rd to 5th tasks and the 7th to 10th tasks satisfy the grouping condition and are grouped. In such a case, the extraction unit 21 excludes the 1st and 2nd tasks that are already assigned from the 1st to 11th tasks arranged in deadline order. Also, from among the multiple remaining 3rd to 11th tasks, the extraction unit 21 excludes the 4th task, the 5th task, and the 8th to 10th tasks which are other than the 3rd task and the 7th task at the front of the grouped tasks. With this arrangement, the extraction unit 21 extracts the 3rd task, the 6th task, the 7th task, and the 11th task.

Note that if the 1st task and the 2nd task are not already assigned, the extraction unit 21 does not exclude the 1st task and the 2nd task. Also, if the 3rd to 5th tasks are not grouped, the extraction unit 21 does not exclude the 4th task and the 5th task. Also, if the 7th to 10th tasks are not grouped, the extraction unit 21 does not exclude the 8th to 10th tasks.

Also, in the example illustrated in FIG. 3, the planning target tasks are arranged in order of earliest deadline, but are not limited to being arranged in order of earliest deadline. For example, the planning target tasks may also be arranged in order of when a request for each task was received.

### (Provisional Order Determination Unit 22)

The provisional order determination unit 22 determines a provisional order by rearranging the multiple tasks extracted by the extraction unit 21 according to a predetermined method. The predetermined method may be the solution to a combinatorial optimization problem, for example. Also, the solution may be a genetic algorithm or a branch and bound algorithm. In the case where the priority of the tasks is specified, the provisional order determination unit 22 determines the provisional order while accounting for the priority. For example, in the case where the priority of another task is set higher than a first task, the provisional order determination unit 22 places the other task ahead of the first task. Also, in the case where work is specified as a priority when the inventory of a specific product is at or below a predetermined lower limit, the provisional order determination unit 22 places a task for producing the product ahead of other tasks. Also, in the case where the priority with respect to customers is specified, the provisional order determination unit 22 determines the provisional order while accounting for the priority. For example, in the case where the priority of another customer is set than a first customer, the provisional order determination unit 22 places the other customer ahead of the first customer.

In the example illustrated in FIG. 3, the provisional order determination unit 22 arranges the 3rd, 6th, 7th, and 11th tasks extracted by the extraction unit 21 into the order of the 11th task, 3rd task, 6th task, and 7th task. This order of the 11th task, 3rd task, 6th task, and 7th task is the provisional order.

### (Correction Unit 23)

The correction unit 23 corrects the provisional order determined by the provisional order determination unit 22 according to a predetermined rule. The predetermined rule may be placing an already-assigned task at the front of the order, for example. Also, the predetermined rule may be placing other tasks other than a first task among grouped tasks in sequential order with the first task, for example. For example, the predetermined rule may be inserting the other tasks after the first task in the case where a first task has the earliest deadline, and inserting the other tasks before the first task in the case where the first task has the latest deadline.

In the example illustrated in FIG. 3, the 1st and 2nd tasks which are already assigned are inserted before the 11th task in first place in the provisional order. Additionally, the correction unit 23 inserts the 4th and 5th tasks, which are tasks not at the front of the grouped tasks, after the third task at the front of the grouped tasks, and also inserts the 8th to 10th tasks after the 7th task at the front of the grouped tasks. The order of the 1st task, 2nd task, 11th task, 3rd task, 4th task, 5th task, 6th task, 7th task, 8th task, 9th task, and 10th task obtained after the correction by the correction unit 23 is the corrected provisional order.

### (Assignment Unit 24)

The assignment unit 24 assigns the planning target tasks to machines and workers in the order of the corrected provisional order corrected by the correction unit 23. At this time, in the case where a work method or processing method for tasks is specified, the assignment unit 24 assigns the tasks while accounting for the specification. For example, in the case where a machine or a worker is specified for a task, the task is assigned to that machine or worker. Note that the running times of machines and the assignment of workers to machines are set in advance. Also, in the case where the times of tasks and resources are specified, the assignment unit 24 assigns the tasks while accounting for the specification. For example, in the case where the time between a first step and another step in a single task is specified, the assignment unit 24 assigns the first step and the other step such that the time between the first step and the other step is longer than the specified time. Similarly, in the case where the time between a first task and another task at the same machine is specified, the assignment unit 24 assigns the first task and the other task such that the time between the first task and the other task is longer than the specified time. Also, in the case where a target work completion date and time for a task or a work acceleration limit time for a task is specified, the assignment unit 24 assigns the tasks while accounting for the specification. For example, the assignment unit 24 assigns a task such that the task is completed earlier than the specified target work completion date and time. Also, in the case where an allowed quantity is specified as the inventory of work in process or a finished product, the assignment unit 24 assigns tasks such that the inventory of the work in process or finished product is less than the allowed quantity. Also, in the case where a task in progress is included and settings for a retention period, a machine to retain, and a worker to retain are retained, the assignment unit 24 assigns the tasks such that the retained items are retained.

In addition, every time a task is assigned, the assignment unit 24 calculates the deadline margin time of the task, and also determines whether or not the calculated deadline margin time is equal to or greater than a deadline margin time specified in advance (hereinafter referred to as the “reference time” in some cases). In the case where the deadline margin time is equal to or greater than the reference time, the assignment unit 24 assigns the next task in the order. On the other hand, in the case where the deadline margin time is shorter than the reference time, the assignment unit 24 assigns the task before a task earlier in the order than the assigned task. Thereafter, the assignment unit 24 recalculates the deadline margin time and again determines whether or not the deadline margin time is equal to or greater than the reference time. In this way, the assignment unit 24 assigns a task by moving the task earlier in the order until the deadline margin time is equal to or greater than the reference time.

Note that in the case of determining whether or not the deadline margin time is equal to or greater than the reference time for grouped tasks, the assignment unit 24 calculates the deadline margin time on the basis of the work time for the grouped tasks as a whole. Additionally, the assignment unit 24 determines whether or not the deadline margin time is equal to or greater than the reference time, and in the case where the deadline margin time is shorter than the reference time, the assignment unit 24 assigns the grouped tasks as a whole before a task earlier in the order than the grouped tasks.

In this way, the assignment unit 24 assigns all of the planning target tasks to create a provisional plan.

In the example illustrated in FIG. 3, the assignment unit 24 assigns tasks sequentially from the 1st task. Additionally, FIG. 3 illustrates an example in which the deadline margin time calculated by assigning the grouped 7th to 10th tasks is shorter than the reference time, and therefore the assignment unit 24 assigns the grouped 7th to 10th tasks before the 6th task earlier in the order, thereby causing the deadline margin time to be equal to or greater than the reference time.

Note that every time a task is assigned, the assignment unit 24 determines whether or not the deadline margin time is equal to or greater than the reference time, and in the case where the deadline margin time is shorter than the reference time, the assignment unit 24 assigns the task before a task earlier in the order than the assigned task. In other words, the assignment unit 24 treats the deadline margin time as a constraint condition, and determines whether to maintain the assignment of a task or moving a task earlier in the order depending on whether or not the constraint condition is satisfied. The constraint condition is not limited to the deadline margin time. For example, the assignment unit 24 may also treat the target work completion date and time of a task as a constraint condition. In other words, after assigning a task to a resource without considering the target work completion date and time, the assignment unit 24 may move a task earlier in the order in the case where the work completion date and time of the assigned task exceeds a specified target work completion date and time.

### (Calculation Unit 25)

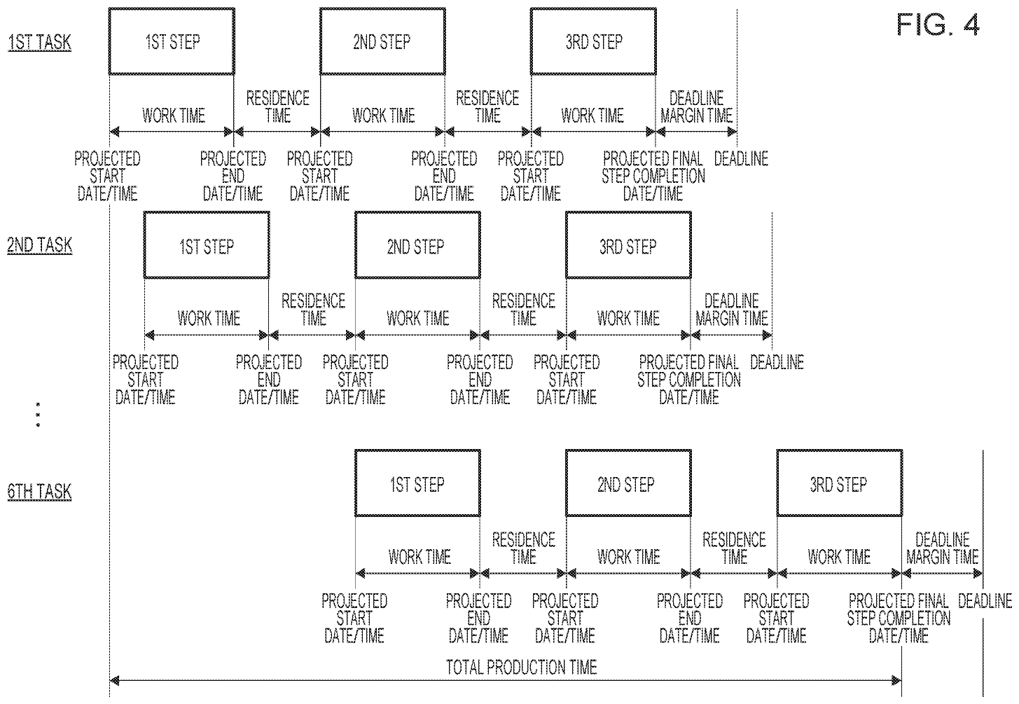

FIG. 4 is a diagram illustrating an example of deadline margin time, residence time, and total production time.

The calculation unit 25 calculates a KPI for the provisional plan that the assignment unit 24 creates by assigning tasks. The KPI may be the average duty of all printing machines, the average duty of all finishing machines, the average production efficiency of all printing machines, the average production efficiency of all finishing machines, the minimum or average deadline margin time of all planned products, the maximum or average residence time between all planned steps, or the total production time, for example. The calculation unit 25 according to the exemplary embodiment calculates a KPI specified by the user from among the above KPIs.

FIG. 4 illustrates an example of a case where, in the example illustrated in FIG. 3, the 1st task assigned first by the assignment unit 24 is a task that completes a product by going through a 1st step (for example, a printing step), a 2nd step (for example, a cutting step), and a 3rd step (for example, a binding step), while the 6th task assigned last by the assignment unit 24 is a task that completes a products by going through a 1st step (for example, a printing step), a 2nd step (for example, a cutting step), and a 3rd step (for example, a binding step). Also, in the example illustrated in FIG. 4, the 1st step of the 1st task is the first step in the plan assigned by the assignment unit 24, and the 3rd step of the 6th task is the last step in the plan assigned by the assignment unit 24. In the case of the above plan, the total production time is the amount of time from the projected start date and time of the first step of the plan, or in other words the projected start date and time of the 1st step of the 1st task, to the projected completion date and time of the last step of the plan. Also, as illustrated in FIG. 4, the deadline margin time is the amount of time obtained by subtracting the projected completion date and time of the last step in each task from the deadline for each task (in other words, the projected delivery date and time of the product produced by the task). Also, the residence time is the amount of time obtained by subtracting the projected completion date and time of a previous step before a given step in each task from the projected start date and time of the given step.

The calculation unit 25 calculates the duty of each machine using the following Expression (1).

Duty (%)=time each machine spends working/running time×100 (1)

Note that the time each machine spends working (hereinafter referred to as the “work time” in some cases) may be the actual work time (for example, the time actually spent printing in the case of a printing machine or the time actually spent cutting in the case of a cutting machine) plus preparation time (for example, the time spent on preparations such as replacing ink and toner in the case of a printing machine or the time spent on preparations such as replacing blades in the case of a cutting machine).

Also, the calculation unit 25 calculates the production efficiency of each printing machine using the following Expression (2).

Production efficiency of each printing machine (pages/hr)=projected number of pages to produce/running time (2)

Also, the calculation unit 25 calculates the production efficiency of each finishing machine using the following Expression (3).

Production efficiency of each finishing machine (copies/hr)=projected number of copies to output/running time (3)

Also, the calculation unit 25 calculates the deadline margin time using the following Expression (4).

Deadline margin time (hrs)=deadline−projected completion time of last step (4)

Also, the calculation unit 25 calculates the residence time using the following Expression (5).

Residence time (hrs)=(projected start time of given step in a task)−(projected completion time of previous step before given step in the task) (5)

Also, the calculation unit 25 calculates the total production time using the following Expression (6).

Total production time (min)=time from projected start date and time of first planned step to projected completion date and time of last planned step (6)

The calculation unit 25 calculates the KPI specified by the user. For example, in the case where the user has set the total production time as the KPI, the calculation unit 25 calculates the total production time.

The calculation unit 25 also determines whether or not the calculated KPI is a more favorable value than a KPI stored in the storage unit 14. For example, in the case where the KPI is the average duty of all printing machines or all finishing machines, it is determined whether or not the calculated KPI is smaller than the KPI stored in the storage unit 14. For example, in the case where the KPI is the average production efficiency of all printing machines or all finishing machines, it is determined whether or not the calculated KPI is larger than the KPI stored in the storage unit 14. For example, in the case where the KPI is the minimum or average deadline margin time, it is determined whether or not the calculated KPI is larger than the KPI stored in the storage unit 14. For example, in the case where the KPI is the maximum or average residence time, it is determined whether or not the calculated KPI is smaller than the KPI stored in the storage unit 14. For example, in the case where the KPI is the total production time, it is determined whether or not the calculated KPI is smaller than the KPI stored in the storage unit 14. Additionally, in the case where the calculated KPI is the more favorable value, the calculation unit 25 stores the KPI in the storage unit 14 and also stores the plan created by assignment in the storage unit 14.

In this way, after the provisional order determination unit 22 determines a first provisional order, the correction unit 23 corrects the first provisional order to set a correct provisional order, the assignment unit 24 assigns tasks to resources, and the calculation unit 25 calculates the KPI for the plan assigned by the assignment unit 24. Additionally, in the case where the KPI calculated by the calculation unit 25 is a more favorable value than the KPI stored in the storage unit 14, the calculation unit 25 stores the KPI and the plan assigned by the assignment unit 24 in association with each other in the storage unit 14.

### (Creation Unit 26)

The creation unit 26 determines whether or not a predetermined end condition is established. The end condition may be that a predetermined number (for example, 10,000) KPIs have been calculated, that the elapsed time since the start of the process has reached a predetermined length of time (for example, three hours), or that the provisional order determination unit 22 has finished determining all provisional orders, for example. Additionally, in the case where the end condition is established, the creation unit 26 treats the assignment having the most favorable KPI stored in the storage unit 14 as a candidate plan.

On the other hand, in the case where the end condition is not established, the creation unit 26 instructs the provisional order determination unit 22 to determine the next provisional order.

In the example illustrated in FIG. 3, the creation unit 26 instructs the provisional order determination unit 22 to determine the next provisional order, thereby causing the provisional order determination unit 22 to determine an order different from the order of the 11th task, 3rd task, 6th task, and 7th task for which the previous KPI was calculated as the provisional order.

Hereinafter, a production plan creation process performed by the control unit 10 will be described using a flowchart.

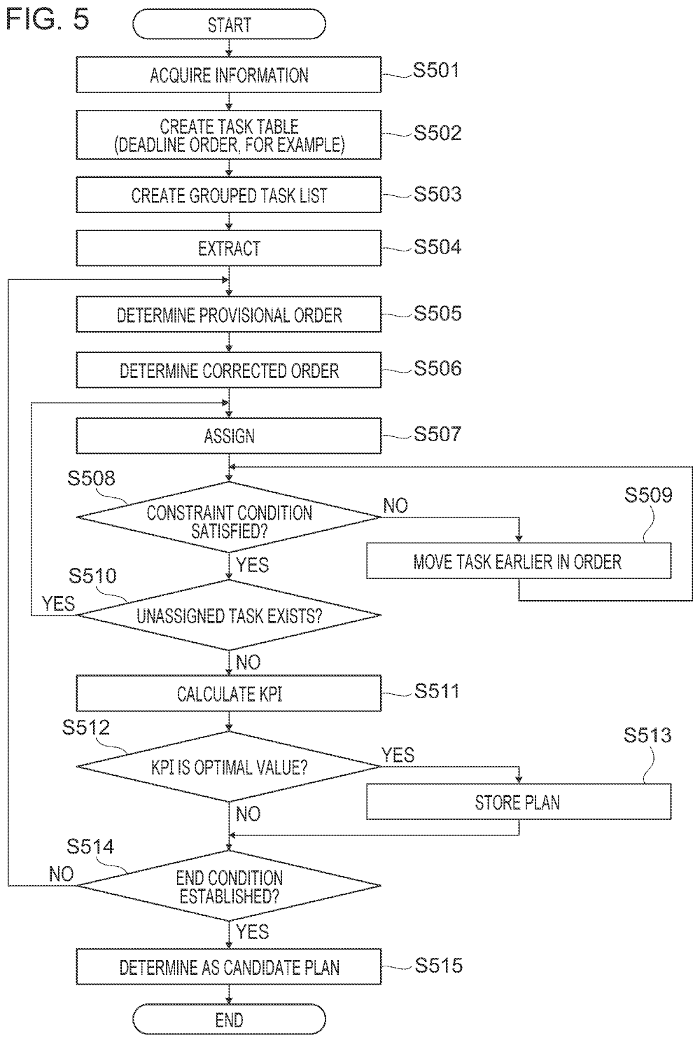

FIG. 5 is a flowchart illustrating one example of a process performed by the control unit 10. The control unit 10 executes the process upon receiving an instruction from the user. The control unit 10 receives the instruction from the user through the operation unit 16 and the display unit 15, for example.

First, the control unit 10 acquires various information, such as information about the planning target tasks, machine operation information, information about the work times of workers, information related to grouping, and information about already-assigned tasks (S501).

The control unit 10 creates a task table in which the planning target tasks acquired in S501 are arranged according to a condition specified in advance (S502). The condition specified in advance may be the order of earliest deadline or the order of shortest deadline margin time, for example. Note that in the example illustrated in FIG. 3, the order created by the process in S502 is an order arranged by deadline.

Thereafter, the control unit 10 creates a list of tasks to group together from grouping-related information specified by the user (S503). For example, in the case where “group tasks by customer” is specified, multiple tasks for the same customer are grouped. Note that in the example illustrated in FIG. 3, the 3rd to 5th tasks and the 7th to 10th tasks are grouped by the process in S503.

Thereafter, the control unit 10 extracts tasks from all of the planning target tasks, excluding already-assigned tasks and grouped tasks other than the task at the front of the group. Note that FIG. 3 illustrates an example in which the 3rd task, the 6th task, the 7th task, and the 11th task are extracted by the process in S504.

The process from S501 to S504 described above is the process performed by the extraction unit 21.

Thereafter, the control unit 10 arranges the multiple tasks extracted by the process in S504 according to a predetermined method to determine a provisional order (S505). This process is the process performed by the provisional order determination unit 22.

Thereafter, the control unit 10 corrects the provisional order determined in S505 to determine a corrected provisional order (S506). In other words, the control unit 10 adds already-assigned tasks to the front of the provisional order. The control unit 10 also inserts grouped tasks other than the task at the front of the group after the task at the front of the group. This process is the process performed by the correction unit 23.

Thereafter, the control unit 10 assigns the planning target tasks to machines and workers according to the corrected provisional order determined in S506 (S507). Additionally, the control unit 10 determines whether or not a constraint condition is satisfied (S508). For example, in the case where the constraint condition is that the deadline margin time is equal to or greater than the reference time, the control unit 10 determines whether or not the deadline margin time of a task assigned in S507 is equal to or greater than the reference time. Additionally, the constraint condition is determined to be satisfied in the case where the deadline margin time is equal to or greater than the reference time, and is determined not to be satisfied in the case where the deadline margin time is less than the reference time.

In the case where the constraint condition is not satisfied (S508, NO), the control unit 10 moves the task assigned in S507 earlier in the order (S509), and performs the process from S508. For example, FIG. 3 illustrates an example in which the deadline margin time calculated by assigning the 7th to 10th tasks is shorter than the reference time, and therefore the control unit 10 assigns the grouped 7th to 10th tasks before the 6th task earlier in the order. In such a case, the previous assignment of the 6th task is removed. On the other hand, in the case where the constraint condition is satisfied (S508, YES), the control unit 10 determines whether or not an unassigned task exists among the tasks in the corrected provisional order determined in S506 (S510). In the case where an unassigned task exists (S510, YES), the control unit 10 performs the process from S507. In the case where an unassigned task does not exist (S510, NO), the control unit 10 performs the process from S511.

The process from S507 to S510 described above is the process performed by the assignment unit 24.

In S511, the control unit 10 calculates the KPI specified in advance for the provisional plan for which assignment is complete (S511). Additionally, the calculation unit 25 determines whether or not the KPI calculated in S511 is a more favorable value than a KPI stored in the storage unit 14 (S512). In the case where the calculated KPI is the more favorable value (S512, YES), the control unit 10 stores the KPI in the storage unit 14 and also stores the provisional plan created by assigning the tasks in the storage unit 14 (S513).

The process from S511 to S513 described above is the process performed by the calculation unit 25.

In the case where the calculated KPI is not the more favorable value (S512, NO), and also in the case after storing the calculated KPI and the like in the storage unit 14 (S513), the control unit 10 determines whether or not a predetermined end condition is established (S514). In the case where the end condition is not established (S514, NO), the control unit 10 performs the process from S505. On the other hand, in the case where the end condition is established (S514, YES), the provisional plan currently being stored in the storage unit 14 is determined as a candidate plan (S515).

The process of S514 and S515 described above is the process performed by the creation unit 26.

### (Display Control Unit 27)

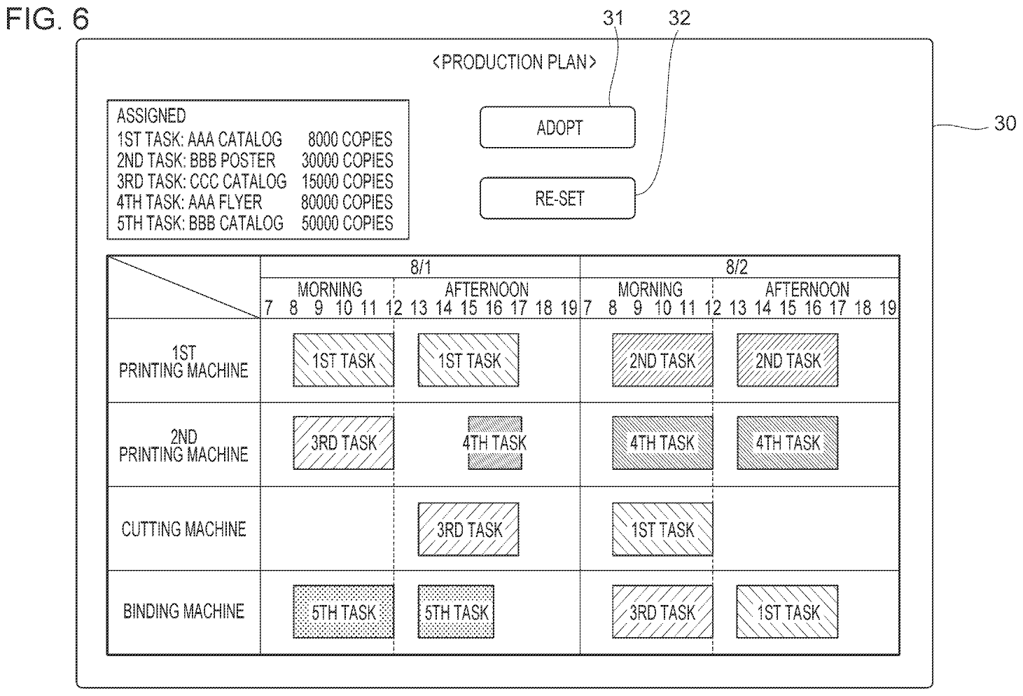

FIG. 6 is a diagram illustrating one example of a candidate plan display screen 30 displayed on a display screen of the display unit 15 by the display control unit 27. Note that FIG. 6 is a simplified illustration of a plan for only two days.

The display control unit 27 outputs data to be displayed on the display screen of the display unit 15, and controls the display of the display screen.

The display control unit 27 causes the candidate plan created by the creation unit 26 to be displayed on the display screen of the display unit 15. For example, as illustrated in FIG. 6, the display control unit 27 causes a candidate plan display screen 30 that displays a plan for producing printed materials to be displayed on the display screen of the display unit 15.

Also, the display control unit 27 causes an adoption image 31 labeled “Adopt” that receives an instruction to adopt the display candidate plan as the final plan to be displayed on the candidate plan display screen 30 displayed on the display screen of the display unit 15. Also, the display control unit 27 causes a re-set image 32 labeled “Re-set” for giving an instruction to create a candidate plan again without adopting the displayed candidate plan as the final plan to be displayed on the candidate plan display screen 30. Note that in the case where the re-set image 32 is specified, the control unit 10 creates a candidate plan again. The case where the re-set image 32 is specified may be when the left button of a mouse is pressed while a cursor is positioned over the re-set image 32, or in other words when the re-set image 32 is clicked, or when a finger is used to press the re-set image 32 displayed on a touch panel, for example. Otherwise, the case where the re-set image 32 is specified may be when a finger is used to touch the re-set image 32 displayed on a touch panel, or when a confirmation button is pressed (such as by pressing the Enter key on a keyboard) while the re-set image 32 is in a selected state (such as while the re-set image 32 is highlighted), for example. However, the configuration is not limited to the above, and the re-set image 32 may also be selected according to another method. Hereinafter, the same also applies to the case where another image (for example, the adoption image 31) is specified.

### (Final Determination Unit 28)

In the case where the adoption image 31 displayed on the candidate plan display screen 30 is specified, the final determination unit 28 determines the candidate plan displayed on the candidate plan display screen 30 as the final plan.

In the exemplary embodiment described above, the functions of the control unit 10 are achieved by causing the CPU 11 given as one example of a processor use the RAM 13 as a work area to execute a program or the like loaded from the ROM 12 or the storage unit 14, but the configuration is not particularly limited to the above. For example, the functions of the control unit 10 may also be achieved by using two or more processors. Note that the term “processor” refers to hardware in a broad sense. Examples of the processor include general processors (such as a CPU) and dedicated processors (such as a graphics processing unit (GPU), an application-specific integrated circuit (ASIC), a field-programmable gate array (FPGA), and a programmable logic device).

Additionally, the production plan creation device 1 configured as above includes a processor (for example, the CPU 11), and the processor acquires information about multiple tasks performed to produce a product using resources, determines a provisional order of two or more tasks among the multiple tasks while accounting for a predetermined condition for performing the multiple tasks (for example, a grouping condition), creates a provisional plan in which resources are assigned in a corrected provisional order given as one example of an order obtained by correcting the provisional order to account for the condition, and creates a candidate plan on the basis of a KPI given as one example of an evaluation of the provisional plan.

According to the production plan creation device 1 configured as above, by determining a grouping condition and the like in advance at a worksite, a candidate plan that accounts for the condition is created. As a result, a plan that accounts for the circumstances at the worksite is created. For example, by determining a condition in advance according to the experience of persons who create plans at a worksite, such as grouping multiple tasks in an order that makes it easy for a worker to perform the work, a plan that reflects the experience of those persons is created.

Here, in the case where the predetermined condition is a condition for grouping several of multiple tasks together, the processor determines a provisional order without including the tasks (for example, the 4th task and the 5th task) other than a specific task (for example, the 3rd task) among the grouped tasks. With this arrangement, the number of tasks to handle when determining a provisional order is lower compared to the case of determining a provisional order with the inclusion of the tasks other than the specific task, and a provisional order is determined more quickly. Also, the number of possible provisional orders is reduced compared to the case of determining a provisional order with the inclusion of the tasks other than the specific task, and consequently a candidate plan is determined more quickly.

Also, the processor corrects the provisional order (for example, inserts the 4th task and the 5th task behind the 3rd task) such that the tasks other than the specific task among the grouped tasks are included according to a predetermined rule (for example, a rule stipulating that the tasks other than the specific task are to be placed after the specific task in the order). This arrangement makes it possible to reduce situations where the order is left undetermined for tasks other than the specific task which are not included in the provisional order. As another example, in the case where the predetermined condition is a condition for grouping multiple tasks for the same customer, the multiple tasks for the same customer are assigned in an order close to each other, thereby causing the products to be completed around the same time.

Also, in the case where the predetermined condition is a condition for assigning already-assigned tasks first, the processor determines a provisional order without including the already-assigned tasks (for example, the 1st task and the 2nd task), and corrects the provisional order such that the already-assigned tasks are placed at the front of the provisional order. With this arrangement, the number of tasks to handle when determining a provisional order is lower compared to the case of determining a provisional order with the inclusion of the already-assigned tasks, and a provisional order is determined more quickly. Also, the number of possible provisional orders is reduced compared to the case of determining a provisional order with the inclusion of the already-assigned tasks, and consequently a candidate plan is determined more quickly.

Also, after evaluating a provisional plan (for example, determining whether or not the KPI is the most favorable value), the processor creates another provisional plan with an order obtained by correcting another provisional plan in which the order of two or more tasks is changed, evaluates the other provisional plan, and treats the plan with the highest evaluation as the candidate plan. With this arrangement, an indicator (for example, the total production time) used when making the evaluation is determined with consideration for the circumstances at the worksite, and a candidate plan that accounts for the circumstances at the worksite is created.

Also, the processor repeatedly determines another provisional order, corrects the other provisional order, and evaluates another provisional plan until a predetermined end condition is established. With this arrangement, by determining an end condition that accounts for the circumstances at the worksite, a candidate plan is created in a form that accounts for the circumstances at the worksite. For example, in the case where the end condition is that elapsed time from the start of the process is a predetermined length of time (for example, three hours), a candidate plan is created by a desired time at the worksite.

Note that in the exemplary embodiment described above, the display control unit 27 causes a candidate plan created by the creation unit 26 to be displayed on the display screen of the display unit 15, and in the case where the user indicates an intention to adopt the candidate plan (for example, if the user specifies the adoption image 31 after checking the candidate plan through the display unit 15), the final determination unit 28 determines the candidate plan as the final plan. However, an exemplary embodiment is not limited to such a configuration. For example, the final determination unit 28 may also determine the candidate plan created by the creation unit 26 as the final plan without an indication of intention by the user. In such a case, the display control unit 27 may cause the final plan determined by the final determination unit 28 to be displayed on the display screen of the display unit 15.

Additionally, the production plan creation device 1 may also include a mechanism for causing the final plan determined by the final determination unit 28 or the candidate plan created by the creation unit 26 to be printed. With this arrangement, the user is able to look at the final plan or the candidate plan on a printed sheet. In the case of such a configuration, the production plan creation device 1 does not have to be provided with the display control unit 27, and the candidate plan created by the creation unit 26 may be printed as the final plan.

### Second Exemplary Embodiment

A production plan creation device 2 according to a second exemplary embodiment includes a control unit 210 instead of the control unit 10 as compared to the production plan creation device 1 according to the first exemplary embodiment. Hereinafter, the points that differ from the first exemplary embodiment will be described. Portions having the same function in the first and second exemplary embodiments will be denoted with the same signs, and a detailed description of such portions will be reduced or omitted.

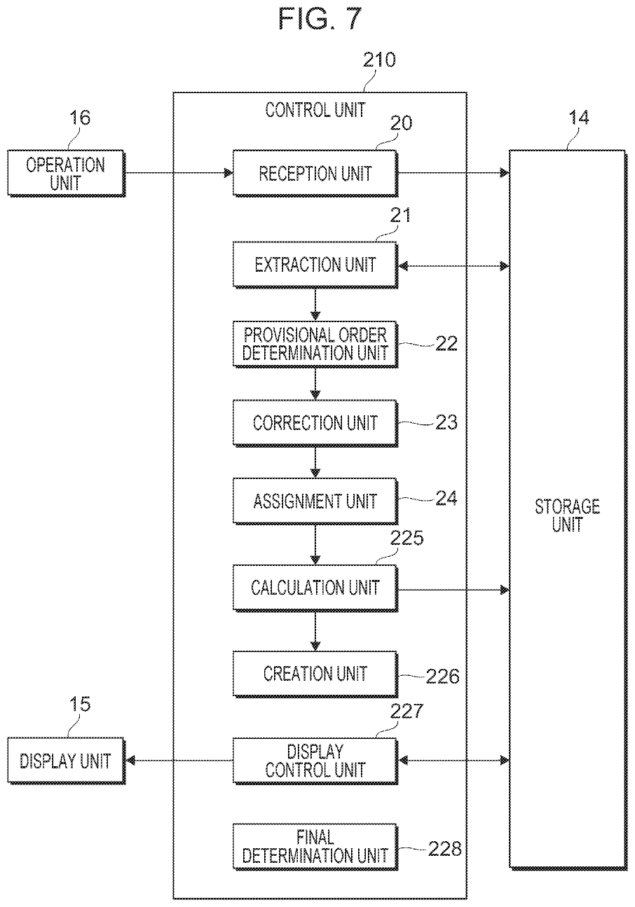

FIG. 7 is a diagram illustrating one example of a block diagram illustrating a functional configuration of the control unit 210 according to the second exemplary embodiment.

Compared to the control unit 10 according to the first exemplary embodiment, the control unit 210 according to the second exemplary embodiment includes a calculation unit 225, a creation unit 226, a display control unit 227, and a final determination unit 228 instead of the calculation unit 25, the creation unit 26, the display control unit 27, and final determination unit 28, respectively.

The calculation unit 225 calculates multiple KPIs specified by the user for the provisional plan assigned by the assignment unit 24. For example, in the case where the total production time, the average value of the residence time (hereinafter referred to as the “average residence time” in some cases), and the average value of the deadline margin time (hereinafter referred to as the “average deadline margin time” in some cases) are specified by the user, the calculation unit 225 calculates the total production time, the average residence time, and the average deadline margin time.

The calculation unit 225 also determines whether or not each of the multiple calculated KPIs is a more favorable value than a KPI stored in the storage unit 14. Additionally, in the case where the calculated KPI is the more favorable value, the calculation unit 225 stores the KPI together with the provisional plan created by the assigning by the assignment unit 24 in the storage unit 14. For example, the calculation unit 225 determines whether or not the calculated total production time is a more favorable value, or in other words a smaller value, than the total production time stored in the storage unit 14. Additionally, in the case where the calculated total production time is a more favorable value than the total production value stored in the storage unit 14, the calculation unit 225 stores the total production time together with the provisional plan created by the assigning by the assignment unit 24 in the storage unit 14.

The creation unit 226 determines whether or not a predetermined end condition is established, and in the case where the end condition is not established, the creation unit 226 instructs the provisional order determination unit 22 to determine the next provisional order. On the other hand, in the case where the end condition is established, the creation unit 226 notifies the display control unit 227 that the end condition is established.

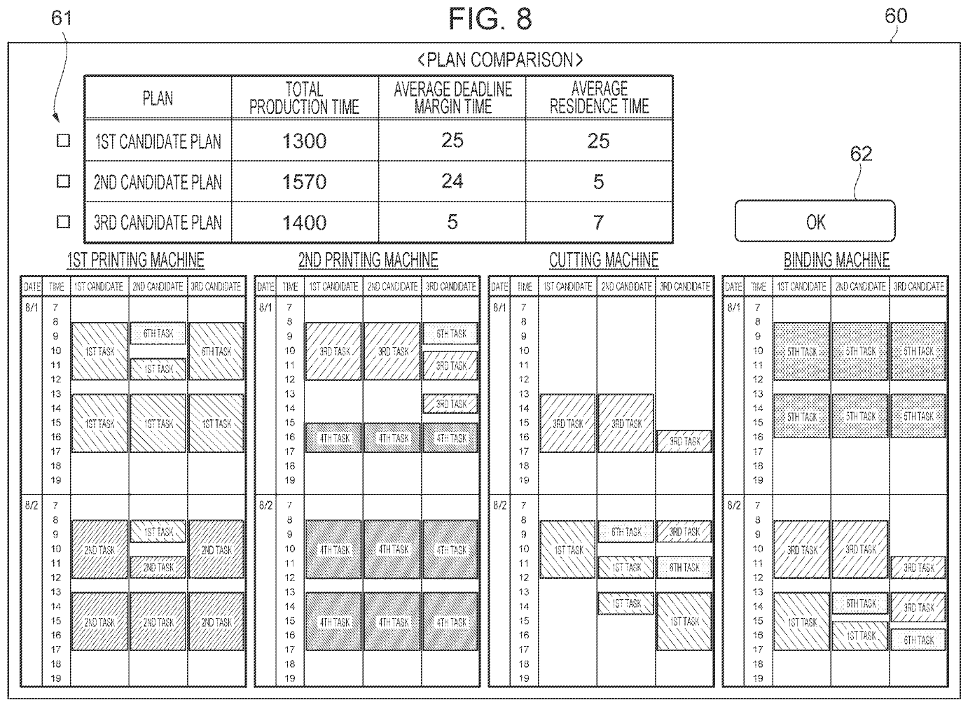

FIG. 8 is a diagram illustrating one example of a comparison screen 60 displayed on the display screen of the display unit 15 by the display control unit 227.

The display control unit 227 causes the provisional plan having the most favorable KPI specified by the user as the highest priority KPI (for example, the total production time) from among the multiple KPIs of the total production time, the average residence time, and the average deadline margin time calculated by the calculation unit 225 to be displayed on the comparison screen 60 as a first candidate plan. Also, the display control unit 227 causes the provisional plan having the most favorable KPI specified by the user as the second-highest priority KPI to be displayed on the comparison screen 60 as a second candidate plan, and causes the provisional plan having the most favorable KPI specified by the user as the third-highest priority KPI to be displayed on the comparison screen 60 as a third candidate plan.

Also, the display control unit 227 causes a selection field 61 enabling the selection of one of the first candidate plan, the second candidate plan, and the third candidate plan to be displayed to the left of each of “First Candidate Plan”, “Second Candidate Plan”, and “Third Candidate Plan” on the comparison screen 60 displayed on the display unit 15. In addition, the display control unit 227 causes a confirmation image 62 labeled “OK” for receiving an instruction confirming one of the first candidate plan, the second candidate plan, and the third candidate plan to be displayed on the comparison screen 60.

In the case where the confirmation image 62 is specified while a mark indicating selection, such as a check mark for example, is displayed in the selection field 61 displayed to the left of each of the first candidate plan, the second candidate plan, and the third candidate plan, the final determination unit 228 determines the selected plan as the final production plan.

In the production plan creation device 2 according to the second exemplary embodiment, the display control unit 227 causes multiple plans having the most favorable value for each of multiple KPIs to be displayed on the display screen of the display unit 15 as candidate plans. Consequently, a person who creates plans at the worksite is able to select the final plan from among the multiple candidate plans by considering the circumstances at the worksite. For example, under circumstances in which the workers have been working continually for many days with long hours, it is possible to select the plan that minimizes the total production time. In this way, according to the production plan creation device 2, a plan that accounts for the circumstances at the worksite is created.

Note that a program executed by the CPU 11 of the control unit 10 or the CPU 11 of the control unit 210 may be provided in a recorded state on a computer-readable recording medium, such as a magnetic recording medium (such as magnetic tape or a magnetic disk), an optical recording medium (such as an optical disc), a magneto-optical recording medium, or semiconductor memory. In addition, the program may also be downloaded by using a communication medium such as the Internet.

In addition, a program forming an exemplary embodiment of the present disclosure causes a processor to execute: a function of acquiring information about multiple tasks performed to produce a product using resources; a function of determining a provisional order of two or more tasks among the multiple tasks while accounting for a predetermined condition for performing the multiple tasks; a function of creating a provisional plan in which resources are assigned in an order obtained by correcting the provisional order to account for the condition; and a function of creating a candidate plan on the basis of an evaluation of the provisional plan.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A production plan creation device comprising:
a processor configured to
acquire information about a plurality of tasks performed to produce a product using resources,
determine a provisional order of two or more tasks among the plurality of tasks while accounting for a predetermined condition for performing the plurality of tasks,
create a provisional plan in which resources are assigned in an order obtained by correcting the provisional order to account for the condition, and
create a candidate plan on a basis of an evaluation of the provisional plan.

2. The production plan creation device according to claim 1, wherein
in a case where the condition is a condition for grouping several of the plurality of tasks together, the processor is configured to determine a provisional order without including tasks other than a specific task among the grouped tasks.

3. The production plan creation device according to claim 2, wherein
the processor is configured to correct the provisional order such that the tasks other than the specific task among the grouped tasks are included according to a predetermined rule.

4. The production plan creation device according to claim 1, wherein
in a case where the condition is a condition for assigning an already-assigned task first, the processor is configured to
determine the provisional order without including the already-assigned task, and
correct the provisional order such that the already-assigned task is placed at a front of the provisional order.

5. The production plan creation device according to claim 2, wherein
in a case where the condition is a condition for assigning an already-assigned task first, the processor is configured to
determine the provisional order without including the already-assigned task, and
correct the provisional order such that the already-assigned task is placed at a front of the provisional order.

6. The production plan creation device according to claim 3, wherein
in a case where the condition is a condition for assigning an already-assigned task first, the processor is configured to
determine the provisional order without including the already-assigned task, and
correct the provisional order such that the already-assigned task is placed at a front of the provisional order.

7. The production plan creation device according to claim 1, wherein
after evaluating the provisional plan, the processor is configured to
create another provisional plan with an order obtained by correcting another provisional plan in which the order of two or more tasks is changed,
evaluate the other provisional plan, and
treat the plan with the highest evaluation as the candidate plan.

8. The production plan creation device according to claim 2, wherein
after evaluating the provisional plan, the processor is configured to
create another provisional plan with an order obtained by correcting another provisional
plan in which the order of two or more tasks is changed, evaluate the other provisional plan, and
treat the plan with the highest evaluation as the candidate plan.

9. The production plan creation device according to claim 3, wherein
after evaluating the provisional plan, the processor is configured to
create another provisional plan with an order obtained by correcting another provisional plan in which the order of two or more tasks is changed,
evaluate the other provisional plan, and
treat the plan with the highest evaluation as the candidate plan.

10. The production plan creation device according to claim 4, wherein
after evaluating the provisional plan, the processor is configured to
create another provisional plan with an order obtained by correcting another provisional plan in which the order of two or more tasks is changed,
evaluate the other provisional plan, and
treat the plan with the highest evaluation as the candidate plan.

11. The production plan creation device according to claim 5, wherein
after evaluating the provisional plan, the processor is configured to
create another provisional plan with an order obtained by correcting another provisional plan in which the order of two or more tasks is changed,
evaluate the other provisional plan, and
treat the plan with the highest evaluation as the candidate plan.

12. The production plan creation device according to claim 6, wherein
after evaluating the provisional plan, the processor is configured to
create another provisional plan with an order obtained by correcting another provisional plan in which the order of two or more tasks is changed,
evaluate the other provisional plan, and
treat the plan with the highest evaluation as the candidate plan.

13. The production plan creation device according to claim 7, wherein
the processor is configured to
repeatedly determine another provisional order,
correct the other provisional order, and
evaluate the other provisional plan until a predetermined end condition is established.

14. The production plan creation device according to claim 8, wherein
the processor is configured to
repeatedly determine another provisional order,
correct the other provisional order, and
evaluate the other provisional plan until a predetermined end condition is established.

15. The production plan creation device according to claim 9, wherein
the processor is configured to
repeatedly determine another provisional order,
correct the other provisional order, and
evaluate the other provisional plan until a predetermined end condition is established.

16. The production plan creation device according to claim 10, wherein
the processor is configured to
repeatedly determine another provisional order,
correct the other provisional order, and
evaluate the other provisional plan until a predetermined end condition is established.

17. The production plan creation device according to claim 11, wherein
the processor is configured to
repeatedly determine another provisional order,
correct the other provisional order, and
evaluate the other provisional plan until a predetermined end condition is established.

18. The production plan creation device according to claim 12, wherein
the processor is configured to
repeatedly determine another provisional order,
correct the other provisional order, and
evaluate the other provisional plan until a predetermined end condition is established.

19. A non-transitory computer readable medium storing a program causing a computer to execute a process for creating a production plan, the process comprising:
acquiring information about a plurality of tasks performed to produce a product using resources;
determining a provisional order of two or more tasks among the plurality of tasks while accounting for a predetermined condition for performing the plurality of tasks;
creating a provisional plan in which resources are assigned in an order obtained by correcting the provisional order to account for the condition; and
creating a candidate plan on a basis of an evaluation of the provisional plan.

20. A production plan creation device comprising:
information acquiring means for acquiring information about a plurality of tasks performed to produce a product using resources;
provisional order determining means for determining a provisional order of two or more tasks among the plurality of tasks while accounting for a predetermined condition for performing the plurality of tasks;
provisional plan creating means for creating a provisional plan in which resources are assigned in an order obtained by correcting the provisional order to account for the condition; and
candidate plan creating means for creating a candidate plan on a basis of an evaluation of the provisional plan.
